(19) United States
(12) Patent Application Publication
(10) Pub. No.: US 2024/0077383 A1
(43) Pub. Date: Mar. 7, 2024

(54) SENSOR MODULE FOR DETECTING A VIBRATIONAL BEHAVIOR OF A COMPONENT

(71) Applicant: Aktiebolaget SKF, Göteborg (SE)

(72) Inventor: Olivier CHEVE, Chanceaux-sur-choisille (FR)

(21) Appl. No.: 18/455,773

(22) Filed: Aug. 25, 2023

(30) Foreign Application Priority Data
Sep. 2, 2022 (DE) 102022209132.9

(51) Int. Cl. G01M 13/045; G01H 11/08

(52) U.S. Cl. CPC G01M 13/045; G01H 11/08

(57) ABSTRACT

A sensor module (8) is disclosed for detecting a mechanical vibration of a component. The sensor module (8) includes a base (10) to be secured on the component. A circuit board (12) is mechanically connected to the base (10). The circuit board (12) has a first side (16) facing the base (10) and a second side (18) facing away from the base (10). A casing (34) inside which is housed the circuit board (12). The casing (34) includes only three contact areas against which the second side (18) of the circuit board (12) abuts.

### CROSS REFERENCE TO RELATED APPLICATION

This application claims priority to German Application No. 102022209132.9, filed Sep. 2, 2022, the entirety of which is hereby incorporated by reference.

### FIELD

The present disclosure generally relates to a sensor module for detecting a vibrational behavior of a mechanical component, and, more specifically, toward a sensor module for detecting a vibrational behavior of an annular bearing component of a vehicle wheel, which sensor module is mountable on the vehicle wheel and configured to wirelessly transmit signals indicative of the detected vibrational behavior.

### BACKGROUND

Mechanical components are subjected to vibrations in various fields of technology. These vibrations may arise from the normal operation of a component or a machine or a system, but they could also indicate a defect or a failure of the component, machine or system. For example, vibrations occurring in rotating components, such as vehicle wheels, could indicate an imbalance or be indicative of bearing damage.

Regardless of whether the vibrations in question are related to normal operation or are indicative of a fault condition, there is a need to detect the vibrational behavior of such a component. Sensor modules can be used for this purpose, which sensor modules may include transmitters for wirelessly transmitting signals indicative of the detected vibrational behavior to a remote receiver.

In order to host transmitters, sensors and the electronic of said sensor module, a sensor module can include a circuit board. For example, the circuit board is housed inside a casing.

The casing comprises many contact areas, for example six contact areas, against which a side of the circuit board abuts.

However, during the production and the assembly of the sensor module, it appears that the creation of six contact areas is not a repetable process, these six contact areas being regularly in a different plan, resulting in a bad and random position of the circuit board. More particularly, the circuit board is in a hyperstatic position.

This problem is generally solved by sorting the products at the end of the production, inducing a waste of components.

There is thus a need to provide a sensor module for detecting a vibrational behavior of a mechanical component that comprises a casing with contact areas in a same plan facilitating the production and assembly of said sensor module.

### SUMMARY

One object of the disclosure is to provide a sensor module configured to detect a mechanical vibration of a component, the sensor module comprising:
a base configured to be secured on the component;
a circuit board mechanically connected to the base and having a first side facing the base and a second side facing away from the base; and
a casing inside which is housed the circuit board.

Advantageously, the casing comprises only three contact areas against which the second side of the circuit board abuts.

This configuration permits to perform the assembly process of the sensor module in a stable way, the circuit board being introduced and positioned against the only three contact areas in order to stabilize as much as possible said circuit board.

In one embodiment, the three contact areas are positioned so that two contact areas are equidistant from the third contact area.

According to one embodiment, one of the contact areas is positioned at a first longitudinal end of the casing, and the two other contact areas are positioned at a second opposite longitudinal end of the casing.

Advantageously, the casing comprises a front part and a mounting skirt extending from the front part and surrounding the circuit board.

Advantageously, the three contact areas define a datum plan parallel to the front part.

In one embodiment, the three contact areas are respectively positioned at the edge of the front part next to the mounting skirt.

Advantageously, the sensor module comprises at least one spacer connecting the base and the circuit board, the at least one spacer being connected to the circuit board in a zone of the circuit board positioned between the three contact areas.

Advantageously, the sensor module comprises a potting material between the casing and the second side of the circuit board.

According to one embodiment, the circuit board comprises a piezoelectric vibration sensor.

One other object of the disclosure is to provide a vehicle wheel assembly comprising:
a wheel having a component comprising studs and;
a sensor module according to any of the preceding claims mounted on the studs of the wheel.

### BRIEF DESCRIPTION OF THE DRAWINGS

Other advantages and features of the disclosure will appear from the detailed description of an embodiment of the disclosure, which is a non-limiting example, illustrated on the appended drawings of which:

FIG. 1 is a front view of a vehicle wheel assembly according to the disclosure;

FIG. 2 is a front view of a sensor module of the vehicle wheel assembly of FIG. 1 according to one embodiment;

FIG. 3 is a cross-section along III-III of FIG. 2;

FIGS. 4 and 5 are perspective views of a casing of the sensor module illustrated in FIG. 2; and

FIG. 6 is a front view of the casing of the sensor module illustrated in FIG. 2.

### DETAILED DESCRIPTION

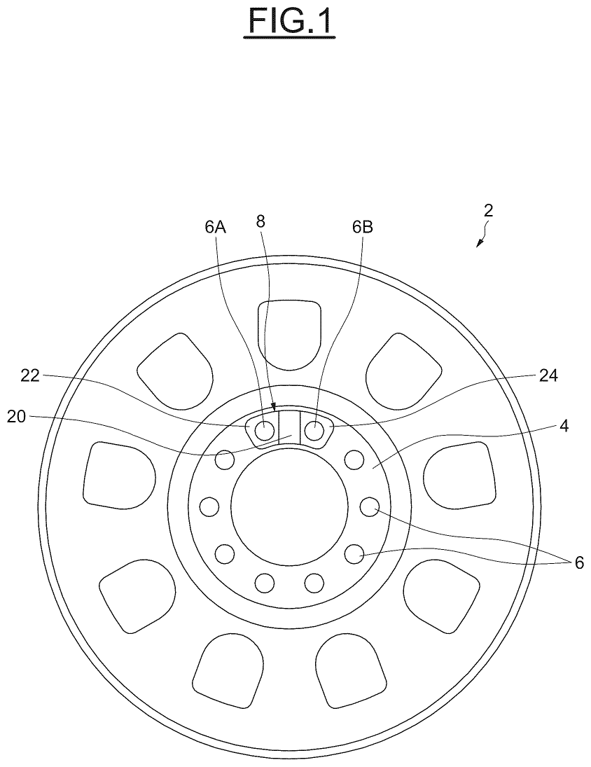

The FIG. 1 shows a vehicle wheel assembly 2 comprising a wheel having a component 4, for example a rim, comprising a plurality of studs 6 and a sensor module 8 mounted on a first stud 6A and a second stud 6B adjacent to the first stud 6A.

The sensor module 8 is configured to detect a mechanical vibration of the component 4. The detected mechanical vibration may be symptomatic of the vibrational behavior of an annular bearing component of the vehicle wheel assembly 2.

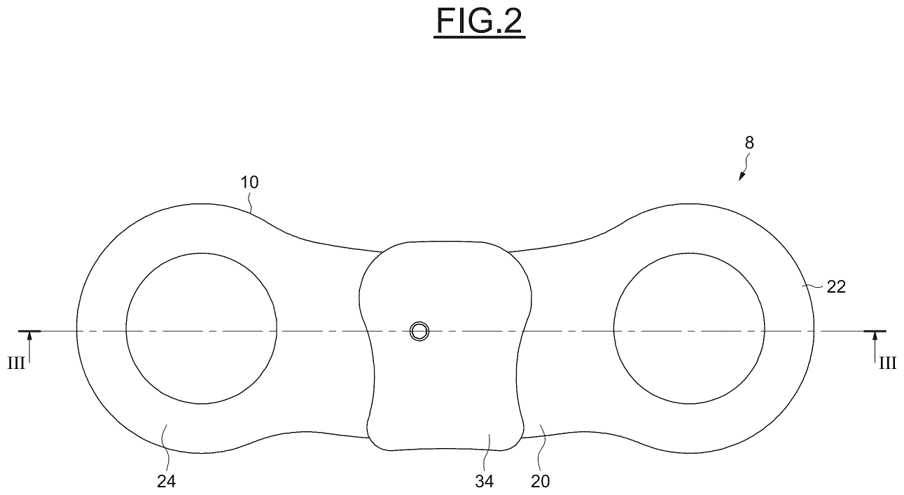

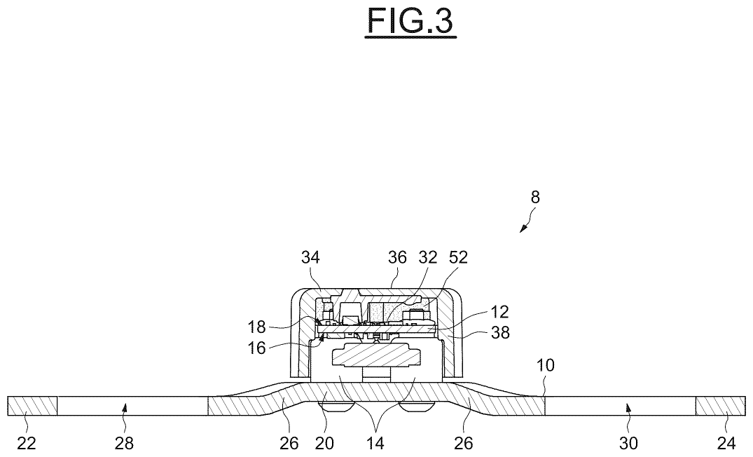

As shown on FIGS. 2 and 3, the sensor module 8 includes a base 10 and a circuit board 12 connected to the base 10 by at least one spacer 14, here by two spacers 14 transmitting the vibrations of the component 4 to the circuit board 12.

The circuit board 12 comprises a first side 16 facing the base 10 and a second side 18 facing away from the base 10. The first and second sides 16, 18 define the thickness of the circuit board 12.

The base 10 comprises a central portion 20, a first end portion 22 and a second end portion 24. The first end portion 22 is connected to one end of the central portion 20 and the second end portion 24 is connected to one opposite end of the central portion 20. The first and second end portions 22, 24 lie substantially in a same plane. The central portion 20 of the base 10 is offset from the plane of the first and second end portions 22, 24 and connected to these first and second end portions 22, 24 by ramps 26.

The first and second end portions 22, 24 of the base 10 are configured to be secured on the component 4 (FIG. 1). To this end, the first end portion 22 of the base 10 comprises a first opening 28 facing the first stud 6A, and the second end portion 24 comprises a second opening 30 facing the second stud 6B so that the sensor module 8 is secured to the component 4 with nuts (not illustrated) both engaged around the studs 6A, 6B.

The circuit board 12 also comprises a piezoelectric vibration sensor 32 mounted on the second side 18 of the circuit board 12. A vibration of the component 4 is thus transmitted by the studs 6A, 6B, the base 10, and the spacers 14 to the piezoelectric vibration sensor 32.

The circuit board 12 may also comprise a wireless transmitter and an antenna (not represented) mounted on the second side 18 of the circuit board 12. A battery (not represented) may also be mounted on the first side 16 of the circuit board 12.

The sensor module 8 also includes a casing 34 inside which is housed the circuit board 12.

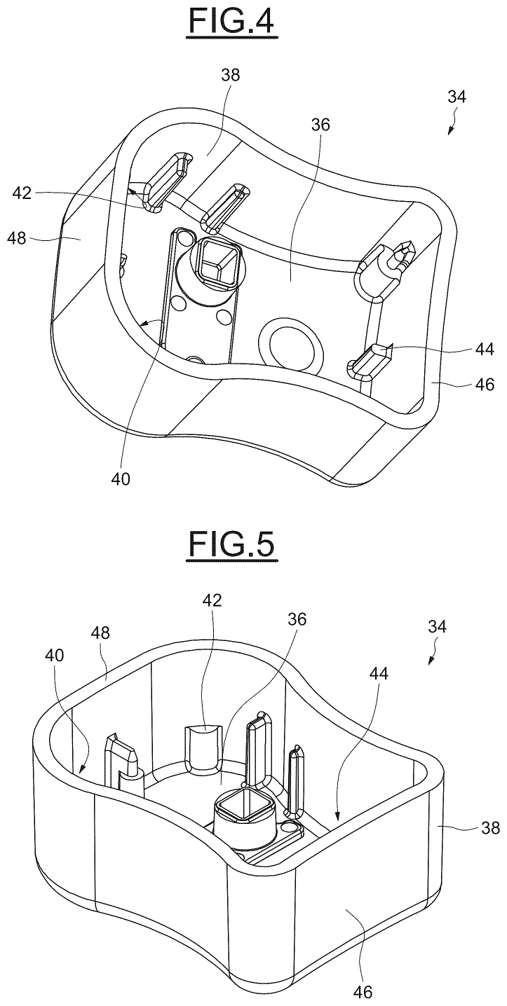

As shown on FIGS. 4, 5 and 6, the casing 34 comprises a front part 36 and a mounting skirt 38 extending from the front part 36 and surrounding the circuit board 12 (not represented on FIGS. 4, 5 and 6).

The casing 34 comprises only three contact areas 40, 42, 44 against which the second side 18 of the circuit board 12 abuts.

Two contact areas 40, 42 are equidistant from the third contact area 44. In other words, the contact areas 40, 42, 44 form the vertices of an isosceles triangle.

In the illustrated embodiment, one contact area 44 is positioned at a first longitudinal end 46 of the casing 34 and the two other contact areas 40, 42 are positioned at a second opposite longitudinal end 48 of the casing 34.

The contact areas 40, 42, 44 are protruding from the front part 36 and from the mounting skirt 38. Alternatively, the contact areas 40, 42, 44 are protruding only from the front part 36 or from the mounting skirt 38.

Advantageously, the contact areas 40, 42, 44 are respectively positioned at the edge of the front part 36 next to the mounting skirt 38 in order to free up space for the circuit board 12 and to increase the stability of the circuit board 12 when housed inside the casing 34.

The contact areas 40, 42, 44 define a datum plan parallel to the front part 36.

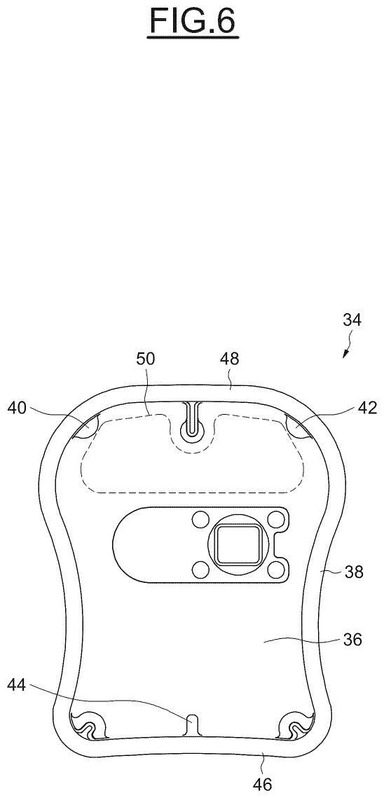

The contact areas 40, 42, 44 and the spacers 14 are positioned so that the spacers 14 are connected to the circuit board 12 in a zone 50 (FIG. 6) of the circuit board 12 destined to be positioned between the three contact areas 40, 42, 44. The spacers 14 being the heaviest elements connected to the circuit board 12 before the assembly of the base 10, this position of the spacers 14 between the three contact areas 40, 42, 44 permits their weight to be correctly dispatch between the contact areas 40, 42, 44.

The sensor module 8 further comprises a potting material 52 (FIG. 3), for example a polymer, between the casing 34 and the second side 18 of the circuit board 12 in order to rigidify and stabilize the circuit board 12 and in order to fix the casing 34 to the circuit board 12. In the described embodiment, the potting material 52 is injected after having housed the circuit board 12 in the casing 34 on the contact areas 40, 42, 44. The good positioning of the circuit board 12 through the contact areas 40, 42, 44 of the casing 34 is thus essential for a correct injection of the potting material 52.

What is claimed is:

1. A sensor module configured to detect a mechanical vibration of a component, the sensor module comprising:
a base configured to be secured on the component;
a circuit board mechanically connected to the base and having a first side facing the base and a second side facing away from the base; and
a casing inside which is housed the circuit board;
wherein the casing comprises only three contact areas against which the second side of the circuit board abuts.

2. The sensor module according to claim 1, wherein the three contact areas are positioned so that two contact areas are equidistant from the third contact area.

3. The sensor module according to claim 1, wherein one of the contact areas is positioned at a first longitudinal end of the casing, and the two other contact areas are positioned at a second opposite longitudinal end of the casing.

4. The sensor module according to claim 1, wherein the casing comprises a front part and a mounting skirt extending from the front part and surrounding the circuit board.

5. The sensor module according to claim 4, wherein the three contact areas define a datum plan parallel to the front part.

6. The sensor module according to claim 4, wherein the three contact areas are respectively positioned at the edge of the front part next to the mounting skirt.

7. The sensor module according to claim 1, further comprising at least one spacer connecting the base and the circuit board, the at least one spacer being connected to the circuit board in a zone of the circuit board positioned between the three contact areas.

8. The sensor module according to claim 1, further comprising a potting material between the casing and the second side of the circuit board.

9. The sensor module according to claim 1, wherein the circuit board comprises a piezoelectric vibration sensor.

10. A vehicle wheel assembly comprising:
a wheel having a component comprising studs; and
a sensor module according to claim 1 mounted on the studs of the wheel.

11. The sensor module according to claim 2, wherein one of the contact areas is positioned at a first longitudinal end of the casing, and the two other contact areas are positioned at a second opposite longitudinal end of the casing.

12. The sensor module according to claim 11, wherein the casing comprises a front part and a mounting skirt extending from the front part and surrounding the circuit board.

13. The sensor module according to claim 12, wherein the three contact areas define a datum plan parallel to the front part.

14. The sensor module according to claim 13, wherein the three contact areas are respectively positioned at the edge of the front part next to the mounting skirt.

15. The sensor module according to claim 14, further comprising at least one spacer connecting the base and the circuit board, the at least one spacer being connected to the circuit board in a zone of the circuit board positioned between the three contact areas.

16. The sensor module according to claim 15, further comprising a potting material between the casing and the second side of the circuit board.

17. The sensor module according to claim 16, wherein the circuit board comprises a piezoelectric vibration sensor.
